(19) United States
(12) Patent Application Publication
(10) Pub. No.: US 2013/0216185 A1
(43) Pub. Date: Aug. 22, 2013

(54) TRANSFORMABLE FERRULE ASSEMBLIES AND FIBER OPTIC CONNECTORS

(71) Applicants: Tory Allen Klavuhn, Newton, NC (US); Thomas Theuerkorn, Hickory, NC (US)

(72) Inventors: Tory Allen Klavuhn, Newton, NC (US); Thomas Theuerkorn, Hickory, NC (US)

(21) Appl. No.: 13/849,604

(22) Filed: Mar. 25, 2013

Related U.S. Application Data
(63) Continuation of application No. PCT/US11/53842, filed on Sep. 29, 2011.
(60) Provisional application No. 61/388,954, filed on Oct. 1, 2010.

(51) Int. Cl. G02B 6/38

(52) U.S. Cl. CPC G02B 6/38
USPC 385/60; 29/401.1

(57) ABSTRACT

Ferrule assemblies and fiber optic connectors that are easily transformable from a female configuration to a male configuration or vice-versa by the craft are disclosed. The ferrule assemblies and/or fiber optic connectors are used with a guide pin keeper that is easily and quickly installed or removed from the ferrule assembly/connector during manufacturing or post-manufacturing process by the craft. The guide pin keeper is installable and/or removable from the ferrule assembly in a direction generally perpendicular to the longitudinal axis of the ferrule assembly without having to disassemble the ferrule boot from the ferrule. Moreover, the guide pin keeper allows installation of the guide pins from the front side of the ferrule. Thus, the guide pin keeper and/or guide pins can easily and quickly be installed or removed during the manufacturing process or in the field by the craft for transforming the ferrule assembly or connector.

### PRIORITY PARAGRAPH

This application is a continuation of International Application No. PCT/US11/53842 filed on Sep. 29, 2011, which claims the benefit of priority to U.S. Provisional Application Ser. No. 61/388,954 filed on Oct. 1, 2010, both applications being incorporated herein by reference.

### BACKGROUND

1. Field of the Disclosure

The disclosure is directed to ferrule assemblies and fiber optic connectors. Specifically, the disclosure is directed to ferrule assemblies and fiber optic connectors that are transformable from a female assembly to a male assembly and vice versa along with related cable assemblies.

2. Technical Background

Fiber optic connectors are used for making a reconfigurable connection between optical fibers. Fiber optic connectors typically use a ferrule for securing a single optical fiber or multiple optical fibers within the connector. Generally speaking, as the number of optical fibers in the fiber optic connector increases then maintaining the alignment between optical fiber cores becomes more difficult. To address this alignment issue, certain multi-fiber fiber optic connectors such as MPO, MTP®, MTRJ, etc. use guide pins for precisely aligning the two mating ferrules so that the relatively small cores of the optical fibers align for transmitting optical signals across the ferrule interface with minimal losses.

When mating optical fiber ferrules using guide pins, only one of the ferrules of the connector requires pins. In other words, one of the mating ferrules has a male configuration that includes guide pins in the ferrule and the other mating ferrule has a female configuration that does not include guide pins. Stated another way, the guide pins of the male ferrule are inserted into the guide pin bores of the female ferrule upon mating, thereby aligning the mating ferrules. Typically, the multi-fiber ferrules are assembled by the manufacturer as either a female ferrule assembly or a male ferrule assembly so the craft connect the same.

However, there are often moves, add, and/or changes to an optical network where a previously “pin-less” connector (i.e., female ferrule) now requires guide pins in the ferrule (i.e., a male ferrule) or vice versa for making an optical connection between the desired ferrules. In some conventional connectors it is either not possible, or practical, to add pins to a female ferrule/connector. For instances, unless a guide pin keeper was originally installed on the female ferrule/connector during the manufacturing process damage to the ferrule/connector may occur when trying to disassemble the connector for installing the guide pin keeper. Moreover, some manufacturers do not install a guide pin keeper on the female ferrule/connector since it is often cost prohibitive.

Some manufacturers design ferrules/connectors so that the guide pin keepers may be installed in the field to transform the female ferrule/connector to a male ferrule/connector, but the craft risks damaging the ferrule/connector when attempting the same. By way of example, FIGS. 1-3 depicts a conventional guide pin keeper 1 having guide pins 3 attached and being installed onto a conventional female fiber optic connector 10. Specifically, FIG. 1 shows the female conventional connector 10 partially disassembled so that conventional guide pin keeper 1 and attached guide pins 3 can be installed for transforming the conventional fiber optic connector 10 into a male connector. Specifically, FIG. 2 shows a craftsman forcibly compressing spring 5 rearward so that the conventional guide pin keeper 1 and attached guide pins 3 can be inserted into the guide pins bores (not numbered) of the ferrule 4 from the rear side of ferrule 4 as shown in FIG. 3. In other words, the conventional connector 10 and the guide pin 3/guide pin keeper 1 assembly requires the operator to forcibly compress the spring and install the guide pin assembly around the fibers from the rear of the ferrule while aligning the pins with the guide pin bores of the ferrule. Stated another way, the guide pin assembly has to have enough clearance at the rear to install the guide pin assembly. This process of transforming the conventional ferrule/connector from a female to male configuration (or vice versa) is difficult and often results in damage to the connector/cable assembly.

Consequently, there is an unresolved need for a simple, quick and craft-friendly assembly for transforming a female ferrule assembly/connector to a male ferrule assembly/connector.

### SUMMARY OF THE DETAILED DESCRIPTION

Embodiments disclosed in the detailed description include ferrule assemblies and fiber optic connectors that are easily transformable from a female configuration to a male configuration or vice-versa by the craft. Specifically, the ferrule assemblies and/or fiber optic connectors use a guide pin keeper that is easily and quickly installed or removed from the ferrule assembly during manufacturing or post-manufacturing process by the craft. The guide pin keeper is installable and/or removable from the ferrule assembly in a direction generally perpendicular to the longitudinal axis of the ferrule assembly without having to disassemble the ferrule boot from the ferrule. Moreover, the guide pin keeper allows installation of the guide pins from the front side of the ferrule. Thus, the guide pin keeper and/or guide pins can easily and quickly be installed or removed during the manufacturing process or in the field by the craft for transforming the ferrule assembly/connector. Moreover, there is little risk in damaging the connector during transformation such as when moves, adds, and/or changes are required to the fiber optic network.

Additional features and advantages will be set forth in the detailed description which follows, and in part will be readily apparent to those skilled in the art from that description or recognized by practicing the concepts described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIGS. 1-3 depict a conventional guide pin assembly being installed onto a female configured connector after the connector is assembled;

FIG. 4 is an exploded perspective view of a ferrule assembly and a guide pin keeper;

FIG. 5 is an assembled perspective view of the ferrule assembly of FIG. 4 prior to the guide pin keeper being slid onto the ferrule assembly in the direction of the arrow;

FIG. 6 is a perspective view of the ferrule assembly of FIG. 4 after the guide pin keeper is installed;

FIG. 7 is a perspective view of the guide pin keeper of FIGS. 4-6;

FIG. 8 is a perspective view showing rotation of the guide pin keeper for releasing and/or securing the guide pins to the assembly; and

FIG. 9 is an exploded view of an explanatory fiber optic connector using the ferrule assembly and guide pin keeper of FIGS. 4-6.

### DETAILED DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

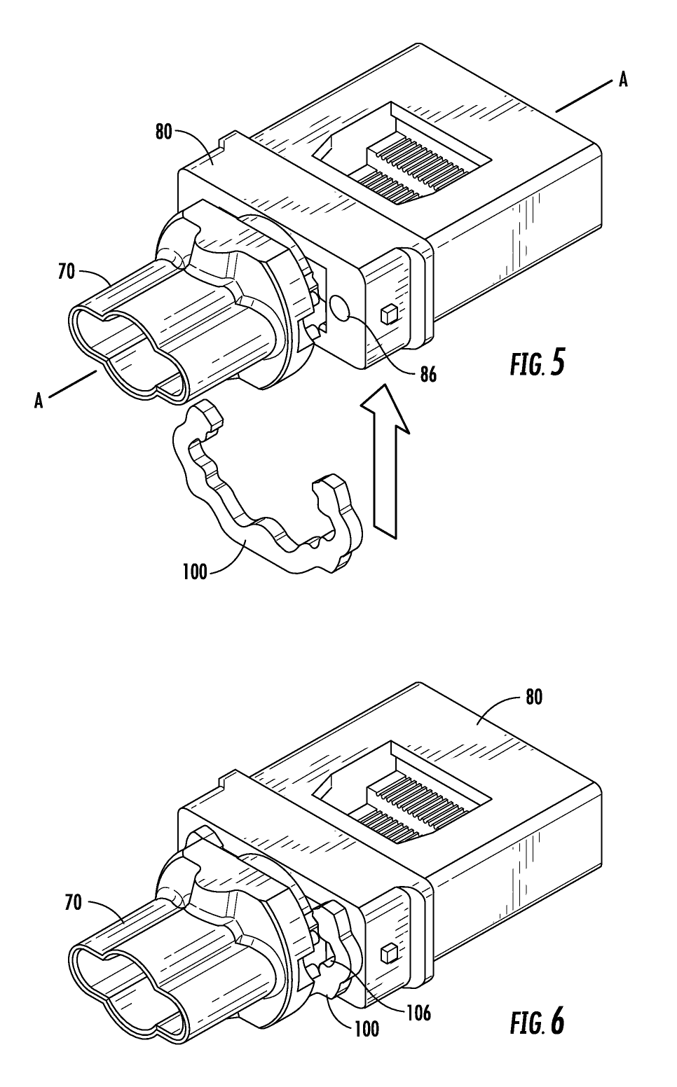

FIG. 4 is an exploded perspective view of a ferrule assembly (not numbered) that includes a ferrule boot 70 and a ferrule 80. Also shown is a guide pin keeper 100 that is installable and removable from the ferrule assembly for transforming the configuration of the ferrule assembly/connector. Ferrule 80 is multifiber ferrule for securing a plurality of optical fibers therein. Moreover, the ferrule assembly can form a portion of a fiber optic connector 200 such as shown in FIG. 9, which may be a portion of a cable assembly. Ferrule 80 has one or more guide pin bores 86 that extend from a front end 82 of ferrule 80 to a rear end 84 of ferrule 80 for receiving a suitably sized guide pin 90 (See FIGS. 4 and 9) in each respective guide pin bore 86. In this embodiment, ferrule 80 has two guide pin bores 86 disposed on opposite sides of an opening at rear end 84 of ferrule 80.

Guide pins 90 are used for precisely aligning mating ferrules so that cores of optical fibers secured in the respective mating ferrules can transmit light across the mating ferrule interface with relatively low-loss. Although, both of the mating ferrules include guide pin bores, the guide pins are only attached to one of the mating ferrules and the other mating ferrule does not have guide pins attached thereto. In other words, one of the mating ferrule assemblies/connectors has a male configuration and the other mating ferrule assembly/connector has a female configuration and the guide pins align the mating ferrules. Often it is necessary to make moves, adds and/or changes to the optical network and the moves, adds and/or changes can require a different type of ferrule configuration/connector (e.g., a male ferrule configuration instead of a female configuration). The ferrule assemblies disclosed herein advantageously provide a quick, simple, and easy method for transforming the assembly from a female ferrule assembly to a male ferrule assembly and vice-versa without risking damage to the assembly during manufacturing or in the field by the craft.

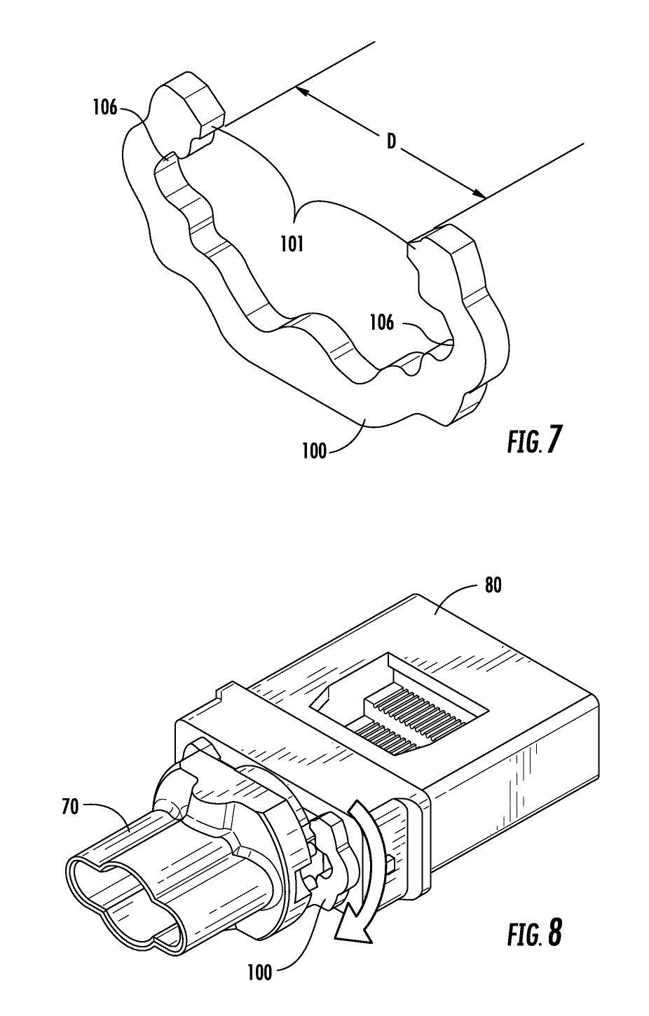

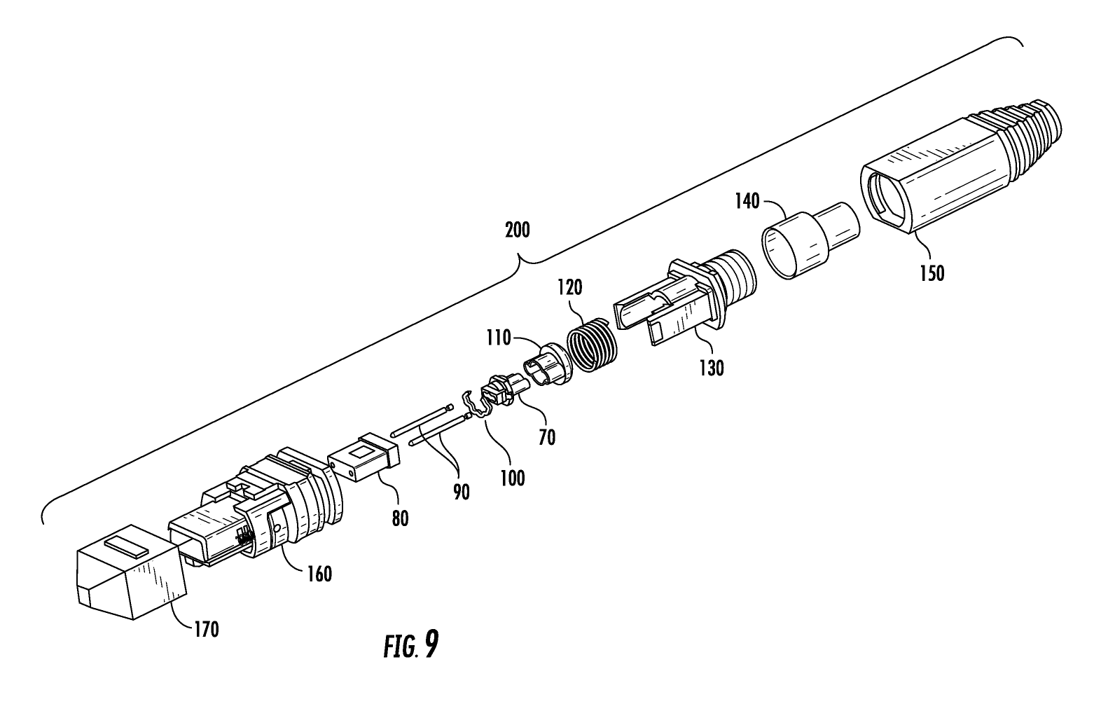

FIG. 5 is an assembled perspective view of the ferrule assembly of FIG. 4 showing the ferrule boot 70 attached to the ferrule 80 as done during manufacturing. Simply stated, the front end of the ferrule boot 70 is inserted into an opening at the rear end of ferrule 84 so a portion of the ferrule boot 70 extends into the ferrule 80, thereby forming the ferrule assembly. As shown, guide pin keeper 100 is installable and removable from the ferrule assembly in a direction generally perpendicular to a longitudinal axis A-A of the ferrule assembly without disassembling the ferrule boot 70 from the ferrule 80 as represented by the arrow. In other words, guide pin keeper 100 is capable of being installed onto or removed from the ferrule assembly by moving (i.e., translating) in the direction of the arrow. Additionally, the guide pin keeper 100 may also rotate during, or after, moving (i.e., translating) in the direction generally perpendicular to the longitudinal axis A-A for securing/releasing the guide pins as shown in FIG. 8. After the guide pin keeper 100 is installed onto the ferrule assembly, one or more guide pins 90 (See FIG. 9) can be inserted into one or more respective guide pin bores 86 from a front end 82 of the ferrule in the longitudinal direction A-A until the one or more guide pins engage the guide pin keeper 100, thereby transforming the assembly from a female configuration to a male configuration. Conversely, one or more guide pins can be removed from one or more respective guide pin bores from a front end 82 of ferrule 80 in a longitudinal direction A-A after the guide pin keeper 100 is removed (and/or rotated) from the ferrule assembly, thereby transforming the ferrule assembly from a male configuration to a female configuration. FIG. 6 is a perspective view showing the ferrule assembly after the guide pin keeper 100 is installed. As shown, guide pin keeper 100 has an opening 106 aligned with the guide pin bores 86 for receiving and securing the guide pins 90 when inserted from the front end 82 of ferrule 80.

FIG. 7 is a perspective view showing the details of guide pin keeper 100. Guide pin keeper 100 includes an open side having a dimension D sized for being received about a portion of ferrule boot 70 as depicted in FIG. 6. Guide pin keeper 100 can have any suitable shape, size, and/or be formed from any suitable material. In this embodiment, guide pin keeper 100 is shaped to fit snuggly about a portion of the ferrule boot 70. For instance, guide pin keeper can have a slight interference fit, friction fit or the like. Additionally, guide pin keeper 100 has an end 101 that is chamfered and/or rounded so that the guide pin keeper 100 can be snapped over ferrule boot 70 in the direction of the arrow a vertical manner as illustrated by the arrow in FIG. 5. Consequently, the guide pin keeper 100 can be easily attached, or removed, and guide pins 90 either installed, or removed, from the guide pin bores 86 at the front end 82 of ferrule 80, thereby transforming the ferrule assembly/connector from a female configuration to a male configuration or vice versa.

Optionally, the guide pin keeper 100 can rotate relative to the ferrule assembly in order to engage the same and/or release/secure the guide pins 90. If the guide pin keeper 100 is to rotate for engagement, an interference feature of the pin keeper is lengthened on one end 101. Thus, instead of simply vertically translating guide pin keeper 100 for installation as represented by the arrow of FIG. 5, the guide pin keeper 100 is also rotated generally about longitudinal axis A-A for securing the same as depicted in FIG. 8. Consequently, the retention of the guide pin keeper 100 is improved when guide pins 90 are not immediately installed into the ferrule assembly and the guide pin keeper 100 is securely retained.

FIG. 9 is an exploded view of an explanatory fiber optic connector 200 using the ferrule assembly and guide pin keeper of FIGS. 4-6. Fiber optic connector 200 includes ferrule boot 70, ferrule 80, guide pins 90, guide pin retainer 100, a cuff 110, a spring 120, a spring push 130, a crimp band 140, a boot 150, an outer housing assembly 160, and a dust cap 170. However, the ferrule assembly and guide pin retainer disclosed herein may be used with other fiber optic connectors having different components and/or assemblies for transforming the fiber optic connector as disclosed herein.

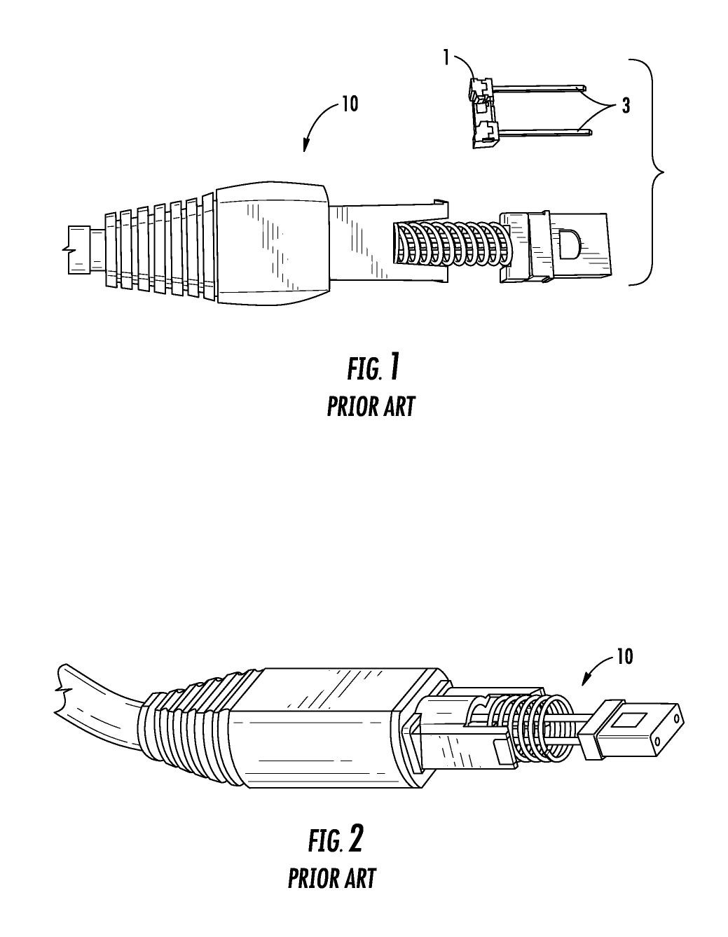

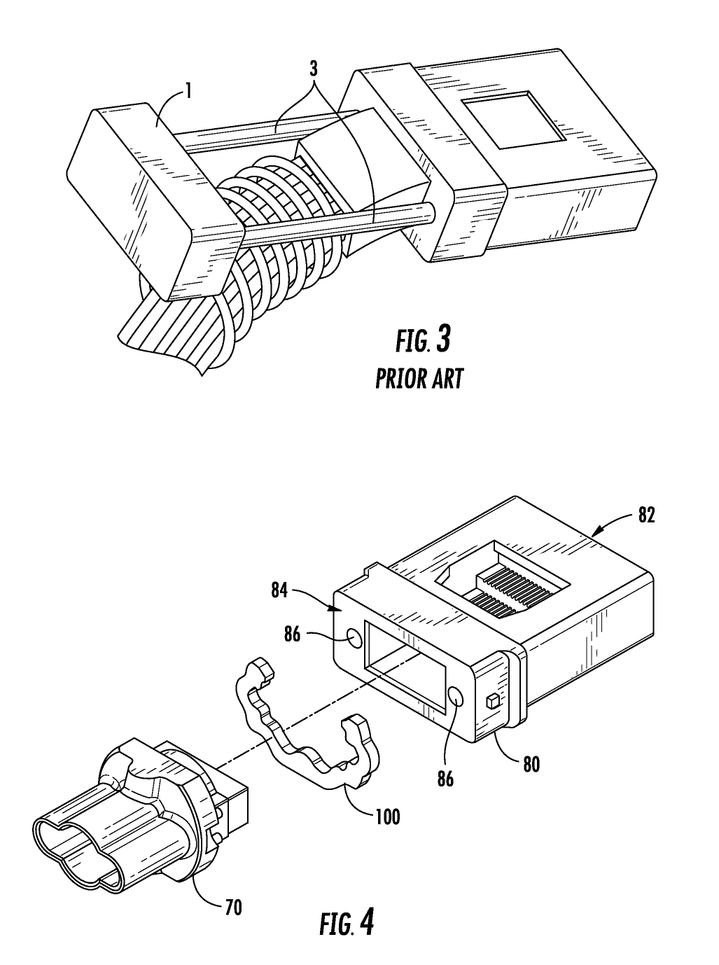

Additionally, the ferrule assemblies and/or fiber optic connectors disclosed herein may be attached to a fiber optic cable and form a cable assembly such as shown in FIG. 1. Other suitable cables assemblies are also possible such as assemblies having furcated legs and a plurality of connectors on respective legs. In one embodiment, the respective legs of the cable assemblies can have staggered leg lengths as desired to reduce the need for slack storage of used lengths.

Many modifications and other embodiments will come to mind to one skilled in the art to which the disclosure pertains having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. It is intended that the embodiments cover the modifications and variations of this disclosure provided they come within the scope of the appended claims and their equivalents. Although specific terms are employed herein, they are used in a generic and descriptive sense only and not for purposes of limitation.

What is claimed is:

1. A ferrule assembly, comprising:
a ferrule having one or more guide pin bores that extend from a front end of the ferrule to a rear end of the ferrule;
a ferrule boot attached to a rear end of the ferrule and defining a longitudinal axis of the ferrule assembly; and
a guide pin keeper that is installable and removable from the ferrule assembly in a direction generally perpendicular to the longitudinal axis without disassembling the ferrule boot from the ferrule.

2. The ferrule assembly of claim 1, wherein the ferrule assembly is a portion of a fiber optic connector.

3. The ferrule assembly of claim 2, the fiber optic connector further including one or more guide pins.

4. The ferrule assembly of claim 2, the fiber optic connector being a multi-fiber connector.

5. The ferrule assembly of claim 2, wherein the fiber optic connector is a portion of a cable assembly.

6. The ferrule assembly of claim 1, wherein the guide pin keeper has a snap-fit with the ferrule boot.

7. The ferrule assembly of claim 1, wherein the guide pin keeper rotates relative to the ferrule assembly for installation or removal from the ferrule assembly.

8. A method of transforming a ferrule assembly, comprising the steps of:
providing a ferrule assembly having a ferrule and a ferrule boot that define a longitudinal axis;
providing a guide pin keeper;
translating the guide pin keeper relative to the ferrule assembly in a direction that is generally perpendicular to the longitudinal axis of the ferrule assembly so the guide pin keeper is either removed from the ferrule assembly or disposed between the ferrule and a portion of the ferrule boot.

9. The method of claim 8, further including the step of inserting one or more guide pins into one or more respective guide pin bores from a front end of the ferrule in a longitudinal direction until the one or more guide pins engage the guide pin keeper, thereby transforming the ferrule assembly from a female configuration to a male configuration.

10. The method of claim 8, further including the step of removing one or more guide pins from one or more respective guide pin bores from a front end of the ferrule in a longitudinal direction, thereby transforming the ferrule assembly from a male configuration to a female configuration.

11. The method of claim 8, further including the step of rotating of the guide pin keeper relative to the ferrule assembly.

12. The method of claim 8, wherein the guide pin keeper has a snap-fit with the ferrule boot.

13. The method of claim 8, the ferrule assembly is a portion of a fiber optic connector.

14. The method of claim 13, wherein the fiber optic connector is a portion of a cable assembly.

15. A ferrule assembly, comprising:
a ferrule having one or more guide pin bores that extend from a front end of the ferrule to a rear end of the ferrule;
a ferrule boot attached to a rear end of the ferrule and defining a longitudinal axis of the ferrule assembly; and
a guide pin keeper that is installable and removable from the ferrule assembly in a direction generally perpendicular to the longitudinal axis without disassembling the ferrule boot from the ferrule, and wherein the guide pin keeper rotates relative to the ferrule assembly for installation or removal from the ferrule assembly.

16. The ferrule assembly of claim 15, wherein the ferrule assembly is a portion of a fiber optic connector.

17. The ferrule assembly of claim 16, the fiber optic connector further including one or more guide pins.

18. The ferrule assembly of claim 16, the fiber optic connector being a multi-fiber connector.

19. The ferrule assembly of claim 16, wherein the fiber optic connector is a portion of a cable assembly.

20. The ferrule assembly of claim 15, wherein the guide pin keeper rotates relative to the ferrule assembly for installation or removal from the ferrule assembly.
